(19) United States
(12) Patent Application Publication
(10) Pub. No.: US 2013/0120465 A1
(43) Pub. Date: May 16, 2013

(54) SYSTEMS AND METHODS FOR DRIVING MULTIPLE LINES OF DISPLAY ELEMENTS SIMULTANEOUSLY

(71) Applicants: Alok Govil, Santa Clara, CA (US); Suryaprakash Ganti, Los Altos, CA (US)

(72) Inventors: Alok Govil, Santa Clara, CA (US); Suryaprakash Ganti, Los Altos, CA (US)

(73) Assignee: QUALCOMM MEMS Technologies, Inc., San Diego, CA (US)

(21) Appl. No.: 13/299,739

(22) Filed: Nov. 18, 2011

Related U.S. Application Data
(60) Provisional application No. 61/558,965, filed on Nov. 11, 2011.

(51) Int. Cl. G09G 5/10; G09G 5/00

(52) U.S. Cl. 345/690; 345/204

(57) ABSTRACT

This disclosure provides systems, methods, and apparatus, including computer programs encoded on computer storage media, for driving a pixel of a display. In one aspect, a segment driver and a common driver may be used to substantially concurrently address all display elements in the pixel. This addressing may reduce write time of the pixel, and may reduce the power consumed during the write process.

### CROSS REFERENCE TO RELATED APPLICATIONS

This application claims priority under 35 U.S.C. Section 119(e) to U.S. Provisional Application 61/558,965, filed on Nov. 11, 2011.

### TECHNICAL FIELD

This disclosure relates to driving schemes and devices for a display, and more specifically to electromechanical systems.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a metallic membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Interferometric modulators can be driven by a column and segment driver which write data to lines of display elements. Generally, as the number of lines increase, the time required to write the data also increases. An increase in the writing time, however, reduces the speed at which images may be displayed. Thus, reduction in the time required to write data is desirable.

### SUMMARY

The systems, methods and devices of the disclosure each have several innovative aspects, no single one of which is solely responsible for the desirable attributes disclosed herein.

One innovative aspect of the subject matter described in this disclosure can be implemented in a display apparatus. The apparatus includes M columns of display elements, N rows of display elements, and a common driver and a segment driver configured to passively address display elements in the M columns and N rows. The segment driver may have more than M outputs for driving the M columns. The common driver may have less than N outputs for driving the N rows. The segment driver may further be configured to supply signals such that more than one row of display elements are driven substantially concurrently by an output of the common driver.

Another innovative aspect of the subject matter described in this disclosure can be implemented in a device for displaying data. The device includes an array of pixels, a common line driver, and a segment driver. One or more pixels in the array may include at least two display elements configured to display a first color and at least two display elements configured to display a second color. The common line driver and the segment line driver may be configured to address one of the two display elements configured to display the first color independently of addressing the other of the two display elements configured to display the first color. The common line driver and the segment line driver may be further configured to address one of the two display elements configured to display the second color independently of addressing the other of the two display elements configured to display the second color. The common line driver and the segment line driver may be further configured to drive the display elements configured to display the first color substantially concurrently with the display elements configured to display the second color.

Yet another innovative aspect of the subject matter described in this disclosure can be implemented in a method of driving a pixel. The pixel includes two or more display elements configured to display a first color and two or more display elements configured to display a second color. The method includes applying a first data signal to one of the two or more display elements configured to display the first color, applying a second data signal to another of the two or more display elements configured to display the first color, applying a third data signal to one of the two or more display elements configured to display the second color, applying a fourth data signal to another of the two or more display elements configured to display the second color, and applying a write pulse to the display elements configured to display the first color and the display elements configured to display the second color while the first, second, third, and fourth data signals are being applied.

Yet another innovative aspect of the subject matter described in this disclosure is an apparatus for displaying information the apparatus may include a first array of display elements including a plurality of rows and columns. Also included may be a first segment driver including a plurality of output lines, there being a greater number of output lines than columns in the first array. The first segment driver may be configured to independently address more than one row of the first array substantially concurrently. The apparatus may further include a second array of display elements including a plurality of rows and columns, and a second segment driver configured to address at least one row of the second array in parallel with the first segment driver addressing rows of the first array.

Yet another innovative aspect of the subject matter described in this disclosure is a display apparatus including M columns of display elements, N rows of display elements, and a switch associated with each display element for active matrix addressing of display elements. A common driver having a plurality of gate driver output lines may include a smaller number of gate driver output lines than rows of display elements. A segment driver having a plurality of data driver output lines may include a larger number of data driver output lines than columns of display elements. The common driver may be configured to drive a gate of a plurality of switches in a corresponding plurality of rows of display elements, and the segment driver may be configured to independently address more than one row of display elements substantially concurrently such that more than one row of display elements are driven substantially concurrently by an output of the common driver.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 shows an example of a diagram illustrating a common driver and a segment driver for driving a color display.

FIG. 10A shows a top plan view of a portion of a display array having bus lines used to provide segment voltages to the display array.

FIG. 10B shows a cross sectional view of a display array showing connections between the bus lines of FIG. 10A and the optical stacks of FIG. 10A.

FIG. 11 shows an example of a diagram illustrating a common driver and a segment driver for driving a color display having display elements of varying size.

FIG. 12 shows an example of a diagram illustrating a common driver with drive lines that latch all display devices in a pixel and a segment driver for driving a color display.

FIG. 13 shows an example of a diagram illustrating a common driver and a segment driver with an increased number of drive lines for driving a color display.

FIG. 14 shows an example of a diagram illustrating a common driver and a segment driver with an increased number of drive lines for driving a color display.

FIG. 15 shows an example of a flow diagram illustrating a process of driving a pixel.

FIG. 16 shows a block diagram illustrating a common driver and two segment drivers for driving two sections of a color display simultaneously.

FIG. 17 shows an example of a schematic circuit diagram illustrating an active matrix driving circuit for an optical MEMS display device.

FIGS. 18A and 18B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

Particular implementations of the subject matter described herein include an increased number of segment drive lines and a decreased number of common drive lines than is known in the art. In some aspects, the number of common drive lines is approximately equivalent to the number of logical common lines in a display. The segment drive lines may be used to concurrently drive all display elements of each pixel along a line of pixels, for example. In some aspects, the display elements are non-uniform in shape. For example, some display elements may be approximately twice the size of other display elements in the same pixel.

Particular implementations of the subject matter described in this disclosure can be implemented to realize one or more of the following potential advantages. The time required to write display data may be reduced when compared to drivers known in the art. This may increase the speed at which images may be displayed, in some aspects even when a greater number of pixels are implemented. Further, power required to drive pixels in a display may be reduced.

One example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

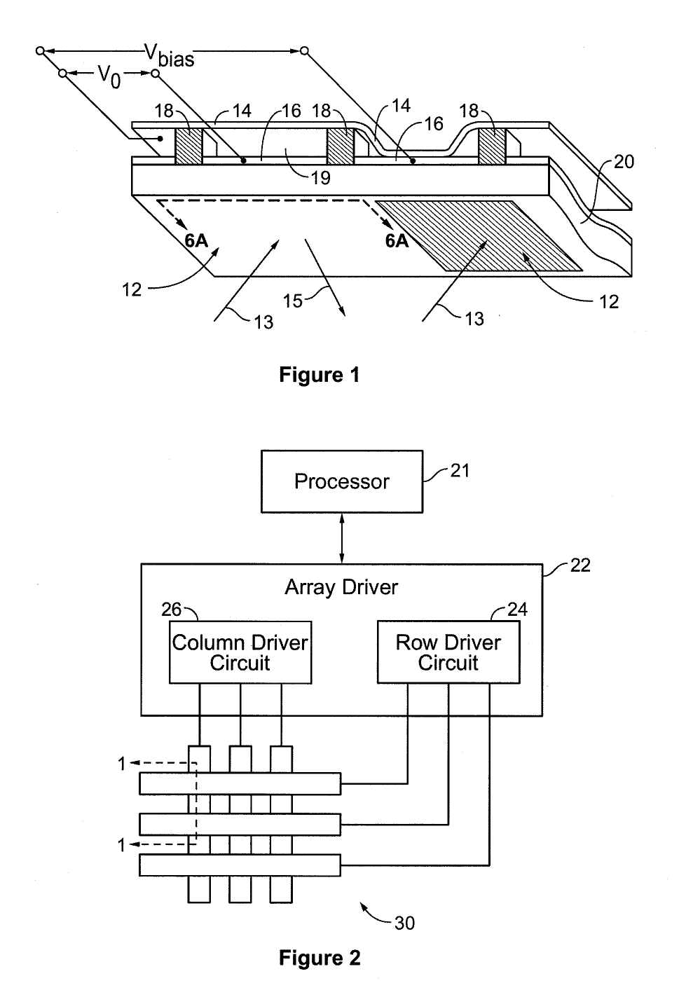

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be on the order of 1-1000 um, while the gap 19 may be on the order of <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14a remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

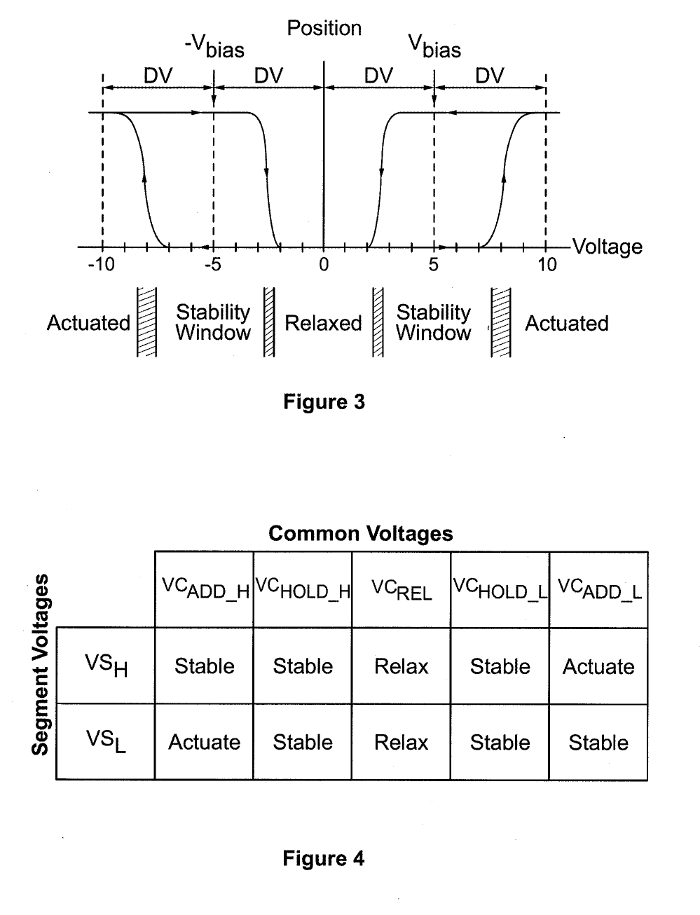

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

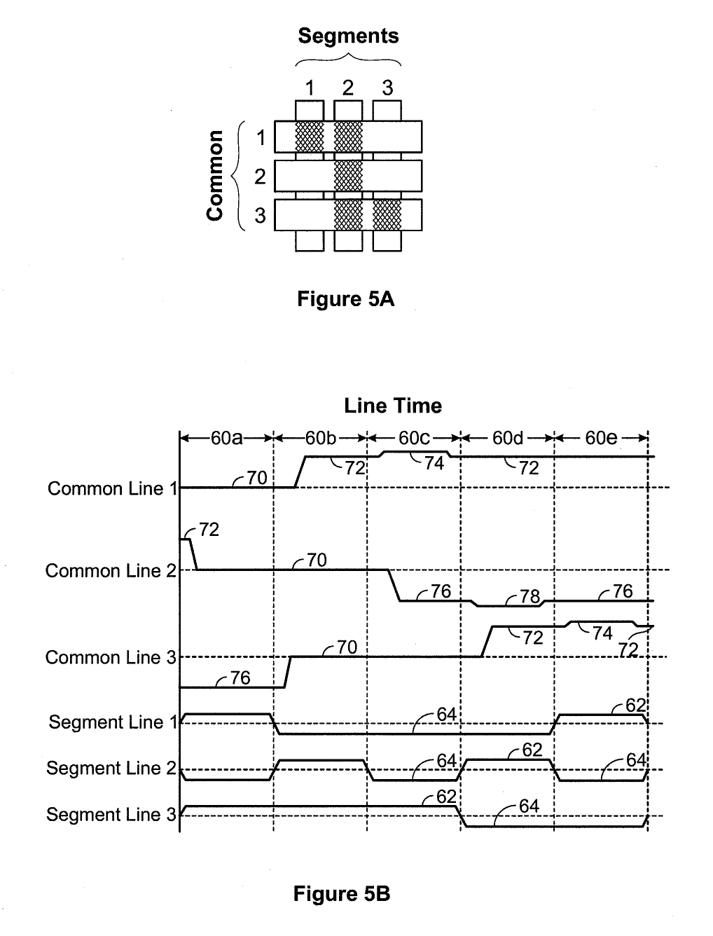

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

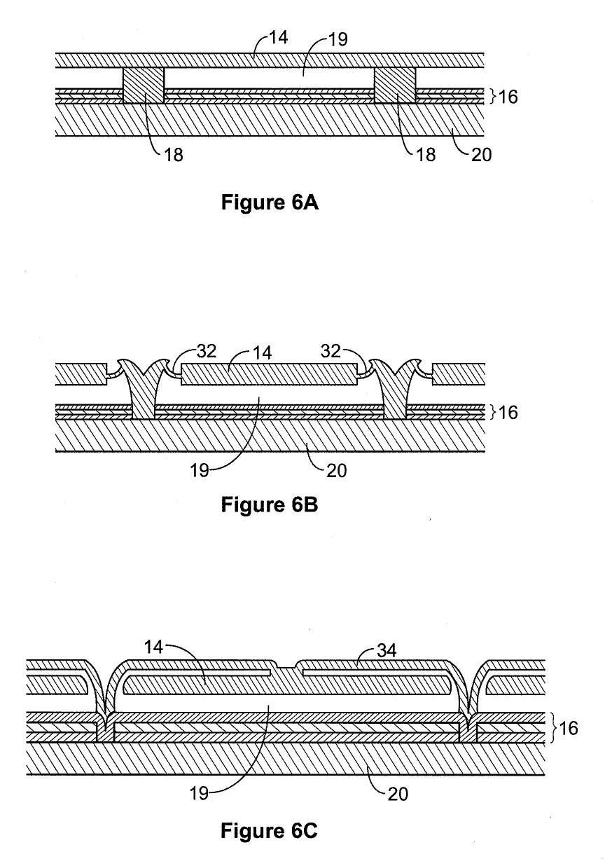

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

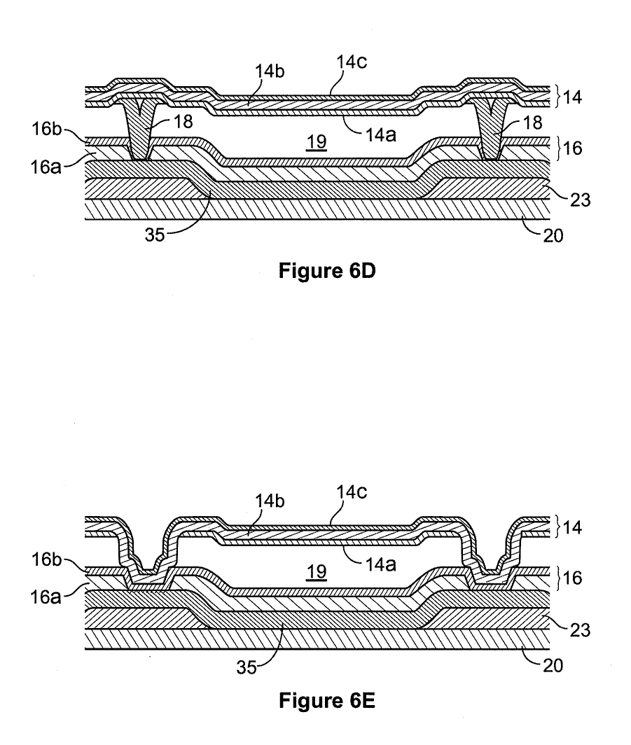

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

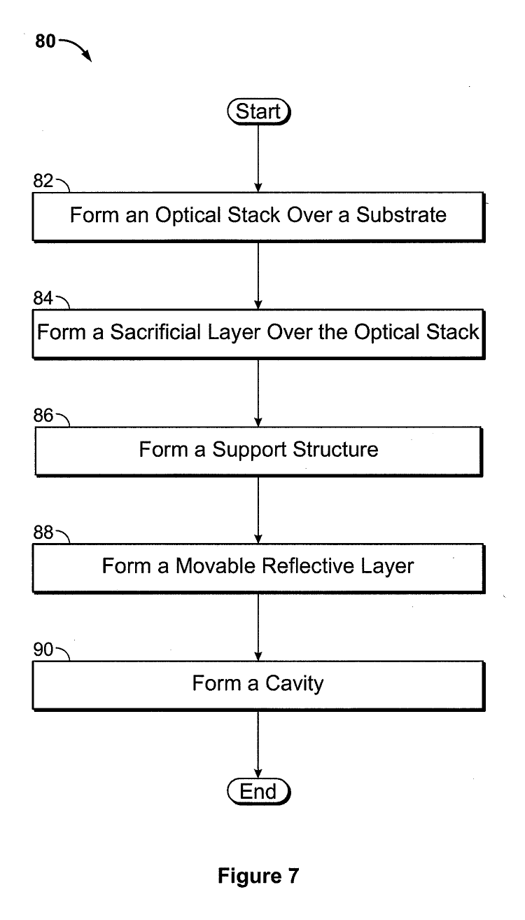

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an Al alloy with about 0.5% Cu, or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, CF₄ and/or O₂ for the MoCr and SiO₂ layers and Cl₂ and/or BCl₃ for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

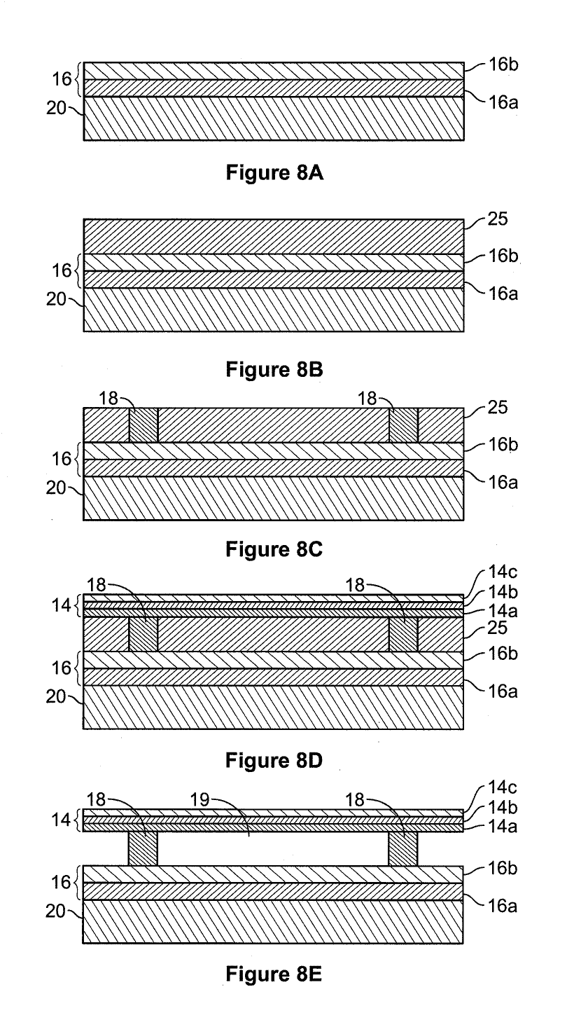

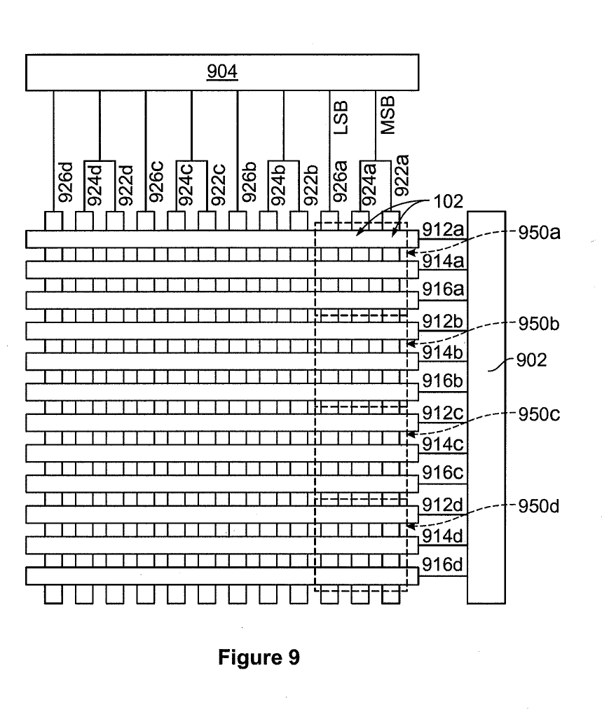

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

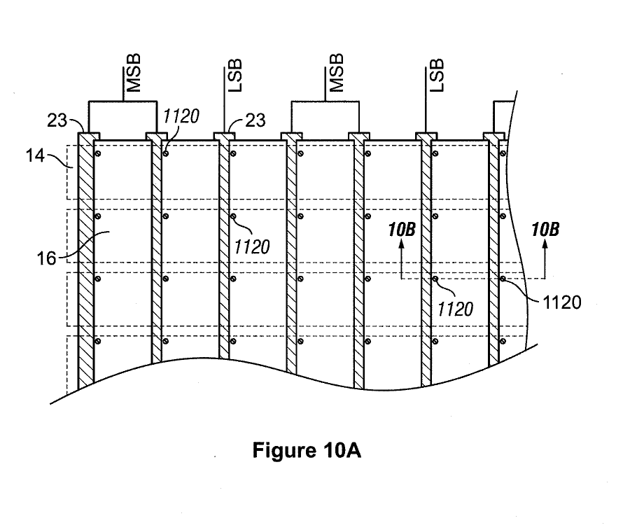

FIG. 9 shows an example of a diagram illustrating a common driver 902 and a segment driver 904 for driving a color display. The color display may include an array of display elements. For example, in the aspect illustrated in FIG. 9, the display includes a plurality of display elements 102 configured to output one or more colors of light. For example, each of the display elements 102 illustrated in FIG. 9 may be configured as an electromechanical display element such as an interferometric modulator, described above.

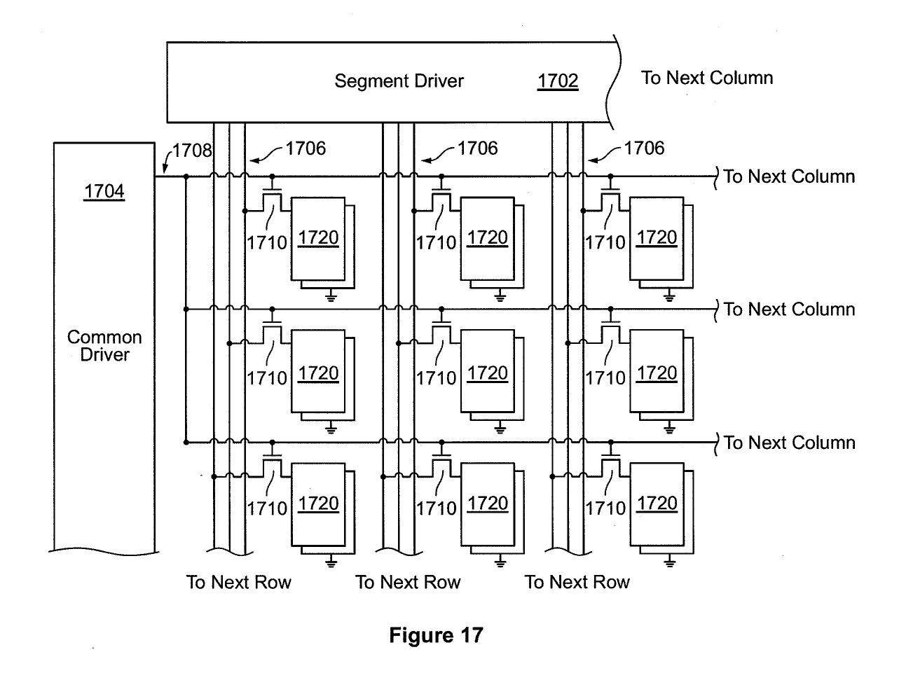

The common driver 902 and the segment driver 904 may be configured to passively address the display elements 102. For example, the segment driver 904 may be configured to apply “segment” voltages, as described above, to drive lines 922a-d, collectively referred to as 922, 924a-d, collectively referred to as 924, and 926a-d, collectively referred to as 926. The common driver 902 may be configured to apply a “common” voltage or signal, as described above, to one of drive lines 912a-d, collectively referred to as 912, 914a-d, collectively referred to as 914, and 916a-d, collectively referred to as 916 while the segment voltages are applied in order to write data to a row of the display elements 102. In this way, the common driver 902 and the segment driver 904 may be used to passively drive the display by sequentially addressing rows of the display elements 102. Thus, as the term is used herein, “passive addressing” refers to drive schemes where the segment voltages are provided to all the elements of the array while each common line is sequentially written. In contrast, “active addressing” schemes isolate the segment voltages with transistor switches as will be described further below with respect to FIG. 17.

As can be seen in FIG. 9, each row of the display elements 102 is associated with one of the drive lines 912, 914, 916. As the number of rows increases, the number of the drive lines 912, 914, 916 correspondingly increases. As each of the drive lines 912, 914, 916 may be sequentially pulsed with a common signal or voltage when writing a frame of data to the display, the time incurred in writing the frame will increase for each additional row. As the write time goes up, the number of frames that can be displayed in any given period of time decreases. Thus, in the display, there is a tradeoff between the number of rows of the display elements 102 and the rate at which data may be written.

In some aspects, the display elements 102 are grouped so as to form logical pixels such as pixels 950a-950d (collectively referred to as 950). In such aspects, the display may include a color display or a monochrome grayscale display. In the illustrated aspect, each pixel 950 comprises nine display elements arranged as three columns by three rows. Thus, for a display configured to be 128 pixels wide by 98 pixels tall, for example, the display may comprise a 384×294 array of display elements.

In some implementations, some of the electrodes of the display may be in electrical communication with one another, such as drive lines 922a and 924a. In such implementations, the same voltage waveform can be simultaneously applied across each of the segment electrodes coupled to these drive lines. Thus, two of the three display elements 102 in each line of a pixel may be driven with the same display data in the illustrated aspect. In some aspects, drive lines that supply data to more than one display element in a row are referred to as most significant bit (MSB) lines, while drive lines that supply data to only one element in a row are referred to as least significant bit (LSB) lines.

In an implementation in which the array includes a color display including a plurality of interferometric modulators, the various colors may be aligned along common lines, such that substantially all of the display elements along a given common line include display elements configured to display approximately the same color. Some implementations of color displays include alternating lines of red, green, and blue subpixels. For example, lines 912 may correspond to lines of red interferometric modulators, lines 914 may correspond to lines of green interferometric modulators, and lines 916 may correspond to lines of blue interferometric modulators. In one implementation, each 3×3 array of interferometric modulators 102 forms one of the pixels 950. In the illustrated implementation in which two of the segment electrodes are shorted to one another, such a 3×3 pixel will be capable of rendering 64 different colors (e.g., a 6-bit color depth), because each set of three common color subpixels in each pixel can be placed in four different states. When using this arrangement in a monochrome grayscale mode, the state of the three pixel sets for each color are made to be identical, in which case each pixel can take on four different gray level intensities. It will be appreciated that this is just one example, and that larger groups of interferometric modulators may be used to form pixels having a greater color range at the cost of overall pixel count or resolution. Further, it will be appreciated that the various colors may be aligned along a column instead of aligned along a row.

As shown in FIG. 9, each row of a pixel may be driven by a separate common drive line. Thus, if there are N rows of logical pixels in the display, the common driver 902 will drive the display elements 102 with 3×N of the drive lines 912, 914, 916. Further, each pixel 950 may be driven by an MSB line and an LSB line, as described above. Thus, if there are M columns of pixels in the display, the segment driver 904 will drive the display elements 102 with 2×M drive lines, where each set of drive lines 922, 924 (such as 922a and 924a) are driven by a common MSB line and the drive lines 926 are driven by a separate LSB drive line.

To latch only one of the colors in one of the pixels 950, the common driver 902 applies a pulse to the drive line associated with that color. Thus, data may separately be written to each color in one of the pixels 950, albeit at different times. For example, segment voltages are applied to the MSB line and the LSB line, and then the drive line associated with the top row of the pixel 950a is pulsed to write data to the elements in the top row of the pixel 950a. Thereafter, segment voltages are applied to the MSB line and the LSB line, and the drive line associated with the middle row of the pixel 950a is pulsed to write data to the elements in the middle row. Subsequently, data may be written to the elements in the last row using a similar procedure.

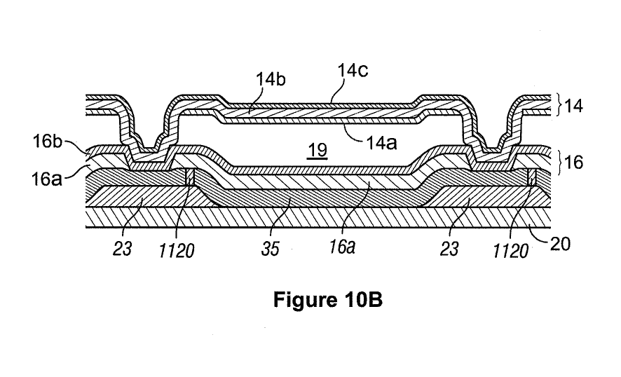

Referring now to FIGS. 10A and 10B, FIG. 10A is a top plan view of a portion of a display array having electrical lines used to provide segment voltages to the display array. FIG. 10B is a cross sectional view of a display array showing connections between the electrical lines of FIG. 10A and the optical stacks of FIG. 10A. In the array of FIGS. 10A and 10B, the strip segment electrodes 16 are illustrated as deposited on a substrate. Beneath and between the segment electrodes 16 are the busses 23. The strip common electrodes 14 running perpendicular to the segment electrodes are shown with dashed lines for clarity. The MSB and LSB signals from the segment driver 904 are applied to the busses 23, and the busses 23 are electrically connected to the segment electrodes 16 with vias 1120 that extend through the insulator 35 of FIG. 10B. Because the busses 23 can be made thicker and of a higher conductivity material than the segment electrodes 16, this can reduce the RC time constant of the load on the driver, and allow the segment electrodes 16 to respond faster to voltage changes applied by the driver 904.

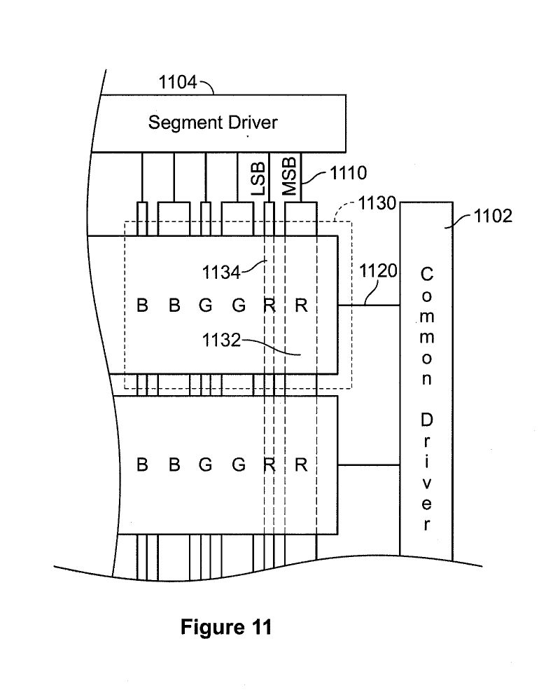

It is advantageous to reduce the time spent writing data to display elements because a reduced write time can result in an increased frame rate. In aspects described herein, a common driver and/or a segment driver for driving a display are configured to reduce the write time for that display. For example, aspects of a column driver and a segment driver illustrated in FIGS. 11-14 may write frames of display data more quickly than the common and segment drivers illustrated in FIG. 9.

FIG. 11 shows an example of a diagram illustrating a common driver 1102 and a segment driver 1104 for driving a color display having display elements of varying size. As illustrated, the display elements may be arranged as an array. In some aspects, the display elements are configured as electromechanical display elements such as interferometric modulators.

The common driver 1102 and the segment driver 1104 may be configured to passively address the display elements. For example, the segment driver 1104 may be configured to apply “segment” voltages, as described above, to drive lines 1110. The common driver 1102 may be configured to apply a “common” voltage or signal, as described above, to one of drive lines 1120 while the segment voltages are applied to write data to a row of the display elements. Thus, the common driver 1102 and the segment driver 1104 may be used to passively drive the display illustrated in FIG. 11 similar to the way in which the common driver 902 and the segment driver 904 drive the display illustrated in FIG. 9. In some aspects, the common driver 1102 is implemented by the row driver circuit 24, and/or the segment driver 1104 is implemented by the column driver circuit 26. In some aspects, the common driver 1102 is implemented by the column driver circuit 26, and/or the segment driver 1104 is implemented by the row driver circuit 24.

In contrast to the segment driver 904, however, each of the drive lines 1110 is associated with a single column of the display elements. Each of the drive lines 1120 of the common driver 1102 is associated with a single row of the display elements, similar to the common driver 902. Thus, each display element may be separately addressed.

In the illustrated aspect, the display elements are grouped so as to form logical pixels such as pixel 1130. In contrast to the pixels 950, the pixel 1130 comprises fewer rows of display elements. The pixel 1130 is contained within one row of display elements. In some aspects, the pixel 1130 is configured to occupy approximately the same area as the pixel 950. In other aspects, the pixel 1130 is sized differently than the pixel 950.

In this implementation, the display elements of the array may have different sizes. For example, as can be seen in FIG. 11, display elements with different widths alternate within the pixel 1130.

In the illustrated implementation, the pixel 1130 comprises elements that display a red color, elements that display a green color, and elements that display a blue color. There are two elements that display each of these colors, with one of the elements being larger than the other. For example, the two elements 1132 and 1134 of the pixel 1130 nearest the common driver 1102 both display a red color, but the red element that is closest to the common driver 1102 is larger than the other red element of the pixel 1130. The different sizes for these two display elements is due to the different widths of the segment electrodes that run underneath the common electrodes. In the implementation of FIG. 11, the width of the segment electrode for element 1132 is twice the width of the segment electrode for element 1134, and therefore the relative red reflectivity contribution from display element 1132 is twice that of display element 1134. In this case, display element 1132 is coupled to an MSB segment driver line, and the display element 1134 is coupled to an LSB segment driver line. Similarly (although not illustrated with dotted lines in FIG. 11), the green element in the pixel 1130 nearest the common driver 1102 is larger than the other green element of the pixel 1130, and the blue element in the pixel 1130 nearest the common driver 1102 is larger than the other blue element of the pixel 1130.

In the illustrated aspect, one of the elements of each color will output more light than the other element of that color. The drive line that supplies data to the element that outputs more light may be referred to as an MSB line, while the drive line that supplies data to the element that outputs less light may be referred to as the LSB line. In contrast to the pixel 950, each color in the pixel 1130 is associated with a separate MSB line and a separate LSB line.

When the pixel 1130 is configured as illustrated in FIG. 11, the pixel 1130 will be associated with six drive lines of the segment driver 1104 and one drive line of the common driver 1102. When there are M columns of pixels, the segment driver 1104 will drive the display elements with 6×M of the drive lines 1110. Further, when there are N rows of pixels, the common driver 1102 will drive the display elements with N of the drive lines 1120.

In this way, each of the elements of the pixel 1130 may be independently and concurrently addressed. Further, the common driver 1102 may apply a single pulse to drive all elements of the pixel 1130, as opposed to the three separate pulses applied by the common driver 902. Thus, although the segment driver 1104 is driving a larger number of drive lines as compared to the segment driver 904, the common driver 1102 and the segment driver 1104 may drive the display illustrated in FIG. 11 with a reduced power dissipation as compared to the driving of the display illustrated in FIG. 9 due at least in part to the reduced number of lines being driven by the common driver 1102.

In the illustrated implementation, each of the display elements is rectangular rather than square, having one dimension that is substantially greater than the other dimension. In some aspects, the area of the display elements that outputs a particular color is substantially equivalent in the pixel 1130 and in the pixel 950. For example, the combined area of the two red display elements in the pixel 1130 may be substantially equivalent to the combined display area of the three red elements in the pixel 950.

In some aspects, one or more of the larger display elements of the pixel 1130 is approximately three times as long as the elements in the pixel 950. In one such aspect, the larger display element is approximately ⅔ the width of the element in the pixel 950. Thus, the display area of the larger element is approximately the same as the combined display areas of two elements in the pixel 950 driven by a single MSB line.

In some aspects, one or more of the smaller display elements of the pixel 1130 is approximately three times as long as the elements in the pixel 950. In one such aspect, the smaller display element is approximately ⅓ the width of the elements in the pixel 950. Thus, the display area of the smaller element is approximately the same as the display area of an element in the pixel 950 driven by a single LSB line.

In the illustrated aspect, the pixel 1130 is configured with a single row of six display elements. The display elements are arranged such that display elements having similar colors are grouped together, and such that each color may be output by two separate display elements. One or more pixels in the display, however, may comprise a greater or fewer number of display elements, rows, and/or columns. Further, the display elements may be configured to display other colors, and that the order or arrangement of the colors may vary. For example, red, green, and blue colored display elements may be interleaved.

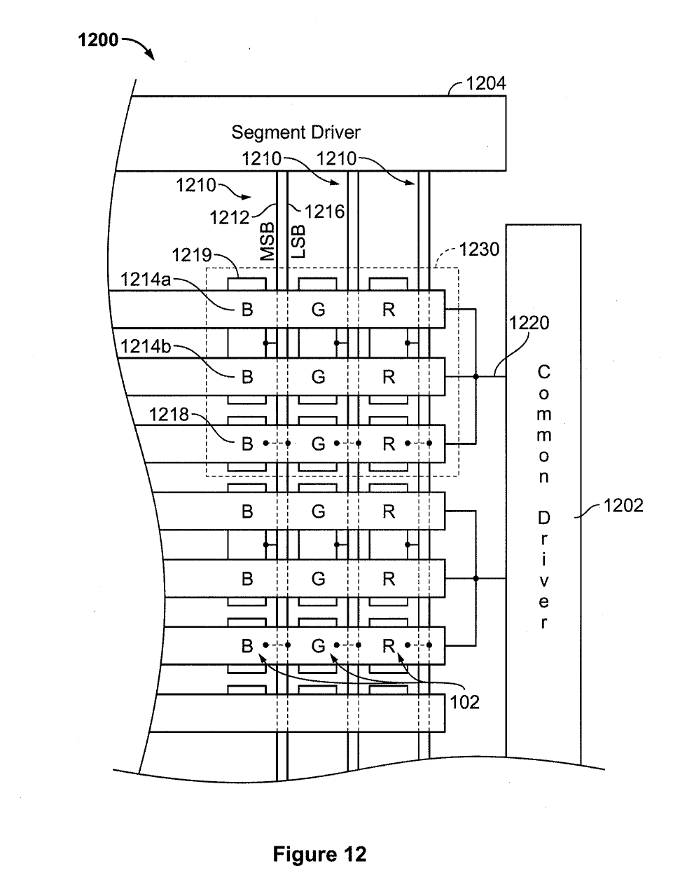

FIG. 12 shows an example of a diagram illustrating a common driver 1202 with drive lines that latch all display elements in a pixel and a segment driver 1204 for driving a color display 1200. As illustrated, the display elements may be arranged as an array. In some aspects, the display elements are configured as electromechanical display elements such as interferometric modulators.

In the illustrated aspect, the display elements comprise the display elements 102 described above. As can be seen in FIG. 12, the display elements 102 are arranged such that all of the display elements 102 in a column display the same color. Similar to the arrangement shown in FIG. 9, the display elements 102 are grouped into pixels such as the pixel 1230. The pixel 1230 comprises nine display elements arranged as three columns by three rows.

The common driver 1202 and the segment driver 1204 may be configured to passively address the display elements 102. For example, the segment driver 1204 may be configured to apply “segment” voltages, as described above, to drive lines 1210. The common driver 1202 may be configured to apply a “common” voltage or signal, as described above, to one of drive lines 1220 while the segment voltages are applied to write data to a row of the display elements 102. Thus, the common driver 1202 and the segment driver 1204 may be used to passively drive the display illustrated in FIG. 12 similar to the way in which the common driver 902 and the segment driver 904 drive the display illustrated in FIG. 9. In some aspects, the common driver 1202 is implemented by the row driver circuit 24, and/or the segment driver 1204 is implemented by the column driver circuit 26. In some aspects, the common driver 1202 is implemented by the column driver circuit 26 illustrated in FIG. 2, and/or the segment driver 1204 is implemented by the row driver circuit 24 illustrated in FIG. 2.

In the illustrated aspect, each of the drive lines 1210 of the segment driver 1204 are associated with display elements of the pixel 1230 of a single color. For example, the two drive lines of the segment driver 1204 disposed nearest the common driver 1202 are both associated with red display elements.

In the illustrated aspect, the drive lines 1210 may be separated into MSB lines, which supply data to more than one display element in a column, and LSB lines, which supply data to only one element in a column. For example, the MSB line 1212 illustrated in FIG. 12 supplies data to the two blue display elements 1214a, 1214b in the pixel 1230 nearest the segment driver 1204, while the LSB line 1216 supplies data to the other blue display element 1218 of the pixel 1230.

In contrast to the aspect illustrated in FIG. 9, each of the drive lines 1220 of the common driver 1202 may be used to substantially simultaneously latch all of the display devices in a pixel. Each of the drive lines 1220 may be split such that a pulse output on one of the drive lines may be communicated to a plurality of rows of the display elements.

When there are M columns of pixels, the segment driver 1204 will drive the display elements with 6×M of the drive lines 1210. Further, when there are N rows of pixels, the common driver 1202 will drive the display elements with N of the drive lines 1220. As shown in FIG. 12, the 6×M drive lines 1210 of the driver 1210 may be configured to provide MSB data and LSB data for each of three colors in a row of pixels substantially concurrently. When a pulse is applied to one of the drive lines 1220 while the MSB and LSB data is being provided, all display elements in the row of pixels will be driven substantially concurrently.

In the illustrated aspect, the display elements in the pixel 1230 which are driven by the MSB line include shared electrodes. Thus, when the segment driver 1204 applies a voltage to the MSB line, the electrode shared by both display elements receives the drive voltage. For example, the two blue elements 1214a and 1214b in the pixel 1230 nearest the segment driver 1204 are formed with a single shared segment electrode 1219. In some aspects, a single display element having an increased area is used instead of two separate display elements sharing a single electrode.

In the illustrated aspect, each of the display elements which are driven by an LSB line include a segment electrode that is electrically isolated from the segment electrode of the surrounding display elements. This arrangement may be contrasted with the display illustrated in FIG. 9, which includes a segment electrode that may extend the length of the display.

The MSB and LSB lines may be implemented by one or more of the busses 23. In some aspects, each bus 23 illustrated in FIG. 10b comprises two electrically isolated portions which form the MSB and LSB lines associated with one of the colors of a pixel. For example, the bus 23 may comprise two portions running parallel to each other and separated by a dielectric. As another example, a first portion of the bus 23 may be deposited on the substrate 20 to form either of the LSB or MSB lines, and a second portion of the bus 23 may be deposited thereon to form the other of the MSB or LSB lines. A dielectric may be formed between the two portions to electrically isolate the two portions. In such aspects, vias may be formed through the second portion to connect the first portion to a segment electrode. Thus, vias in addition to the vias 1120 illustrated in FIG. 10B may be formed in these aspects.

Similar to the common driver 1102 and the segment driver 1104, the common driver 1202 and the segment driver 1204 may drive the display illustrated in FIG. 12 with a reduced power dissipation as compared to the driving of the display illustrated in FIG. 9 due at least in part to the reduced number of lines being driven by the common driver 1202.

One having ordinary skill in the art will appreciate that each pixel in the display 1200 may comprise a greater or fewer number of display devices, rows, and/or columns than illustrated. One having ordinary skill in the art will further appreciate that the display devices may be configured to display other colors, and that the order or arrangement of the colors may vary.

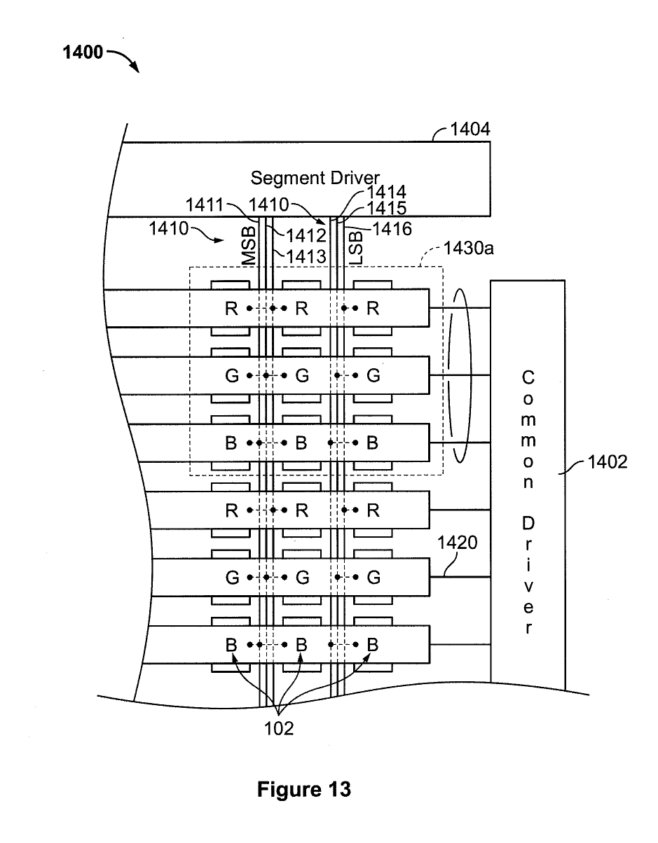

FIG. 13 shows an example of a diagram illustrating a common driver 1402 and a segment driver 1404 with an increased number of segment lines, as compared to the segment driver 904 illustrated in FIG. 9, for driving a display. As illustrated, the display elements may be arranged as an array. In some aspects, the display elements are configured as electromechanical display elements such as interferometric modulators.

In the illustrated aspect, the display elements comprise the display elements 102 described above. As can be seen in FIG. 13, the display elements 102 are arranged similar to the arrangement described with respect to FIG. 9, with the each color being associated with a line of the common driver 1402. Similar to the arrangement in FIG. 9, the display elements are grouped into pixels such as the pixel 1430a. The pixel 1430a comprises nine display elements arranged as three columns by three rows.

The common driver 1402 and the segment driver 1404 may be configured to passively address the display elements 102. For example, the segment driver 1404 may be configured to apply “segment” voltages, as described above, to drive lines 1410. The common driver 1402 may be configured to apply a “common” voltage or signal, as described above, to one or more of drive lines 1420 while the segment voltages are applied to write data to one or more rows of the display elements 102. Thus, the common driver 1402 and the segment driver 1404 may be used to passively drive the display illustrated in FIG. 13 similar to the way in which the common driver 902 and the segment driver 904 drive the display illustrated in FIG. 9. In some aspects, the common driver 1402 is implemented by the row driver circuit 24 of FIG. 2, and/or the segment driver 1404 is implemented by the column driver circuit 26 of FIG. 2. In some aspects, the common driver 1402 is implemented by the column driver circuit 26 illustrated in FIG. 2, and/or the segment driver 1404 is implemented by the row driver circuit 24 illustrated in FIG. 2.

In contrast to the aspect illustrated in FIG. 9, however, a separate one of the drive lines 1410 of the segment driver 1404 is associated with display elements of the pixel 1430 of each color that receive MSB data, and a separate one of the drive lines 1410 is associated with display elements of each color of the pixel 1430 that receive LSB data. For example, one of the drive lines 1411 is associated with the two red display elements of the pixel 1430 which are farthest from the common driver 1402, and these two red elements will both display the same MSB data. Similarly, another one of the drive lines 1412 is associated with the two green display elements of the pixel 1430 which are farthest from the common driver 1402, and yet another one of the drive lines 1413 is associated with the two blue display elements of the pixel 1430 which are farthest from the common driver 1402. Further, separate ones of the drive lines 1414, 1415, and 1416 are respectively associated with each of the red, green, and blue display elements of the pixel 1430 nearest the common driver 1402, all of which are configured to display LSB data.

In contrast to the segment driver 1204 illustrated with respect to FIG. 12, the MSB lines of the segment driver 1404 that provide data to the pixel 1430a are shown as being grouped together. Further, the LSB lines of the segment driver 1404 that provide data to the pixel 1430a are also shown as being grouped together. In FIG. 12, the MSB and LSB lines that provide data to each pixel are shown as being interleaved. One having ordinary skill in the art, however, will appreciate that the MSB and LSB lines may be organized into any number of configurations based on the arrangement of the display elements within a pixel.

Similar to the display discussed above with respect to FIG. 12, the MSB and LSB lines illustrated in FIG. 13 may be implemented by one or more of the busses 23 (see, foe example, FIGS. 10a and 10b). In some aspects, each bus 23 illustrated in FIG. 10b comprises three electrically isolated portions which form the group of MSB lines, or which form the group of LSB lines, associated with the pixels of the column. For example, the bus 23 may comprise three electrically isolated layers having vias formed therein to allow each of the layers to communicate with a segment electrode of a respective display element. In the illustrated implementation, the segment electrode of each display element 102 is illustrated as being electrically isolated from the segment electrodes of surrounding display elements.

The common driver 1402 is shown as having a drive line 1420 associated with each row of display elements in the display 1400, similar to the common driver 902. The common driver 1402, however, may be configured to address a plurality of the drive lines 1420 substantially concurrently. For example, the common driver 1402 may be configured to apply an addressing pulse to all three of the drive lines 1420 associated with the pixel 1430 substantially simultaneously. In this way, all display elements in a row of pixels may be driven substantially concurrently. Further, MSB data and LSB data for each color in the row of pixels may be independently provided.

In some aspects, one or more of the drive lines 1420 may be used to provide a signal to two or more rows of the display elements. For example, in one aspect, the common driver 1402 includes only one drive line associated with the pixel 1430a instead of the three that are illustrated. In this aspect, the one drive line may be split into three lines and each of the three lines may be associated with a row of the display elements in the pixel 1430a. In this way, one signal output by the common driver 1402 will be applied to all of the rows of display elements in the pixel 1430a. Another implementation of a common driver having split drive lines was described above with respect to FIG. 12. The configuration having each row associated with a different one of the drive lines 1420 illustrated in FIG. 13, however, may allow the common driver 1402 to apply a different pulse to each color of display element. For example, different voltages may be applied to the red and blue elements, or waveforms having a different shape may be applied to the green and red elements. Thus, although every element of the pixel 1430a may be driven substantially concurrently, each color may receive a different signal from the common driver 1402. Thus, the signal applied to each element may be adjusted based on the physical differences between the display elements of each color, for example based on varied gap distances between the electrodes of display elements of different colors.

In some aspects, the common driver 1402 may instead or in addition be configured to stagger the assertion of pulses to two or more of the drive lines 1420 associated with a pixel. In such aspects, rows of the display elements may be sequentially addressed, and operation of the display illustrated in FIG. 13 may mimic operation of the display illustrated in FIG. 9.

When there are M columns of pixels, the segment driver 1404 will drive the display elements with 6×M of the drive lines 1410. Further, when there are N rows of pixels, the common driver 1402 will drive the display elements with 3×N of the drive lines 1420 when configured as shown in FIG. 13. When one or more of the drive lines 1420 are split, the common driver 1402 may drive the display elements with between N and 3×N drive lines.

One having ordinary skill in the art will appreciate that each pixel in the display 1400 may comprise a greater or fewer number of display devices, rows, and/or columns than illustrated. One having ordinary skill in the art will further appreciate that the display devices may be configured to display other colors, and that the order or arrangement of the colors may vary.

One having ordinary skill in the art will appreciate that each pixel in the display illustrated in FIG. 13 may comprise a greater or fewer number of display devices, rows, and/or columns than illustrated. One having ordinary skill in the art will further appreciate that the display devices may be configured to display other colors, and that the order or arrangement of the colors may vary.

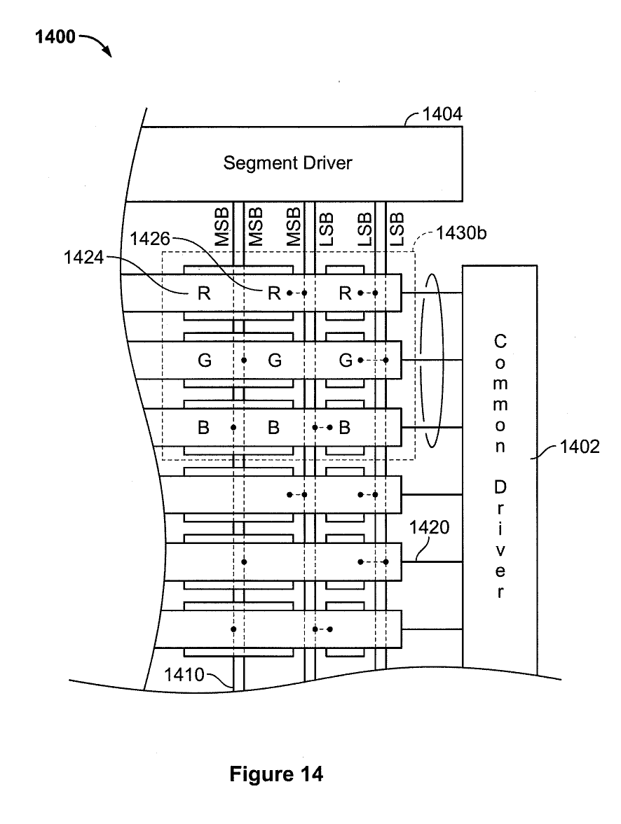

FIG. 14 shows an example of a diagram illustrating the common driver 1402 and a segment driver 1404 with an increased number of drive lines. The example shown in FIG. 14 differs from the example shown in FIG. 13 in that one of the MSB lines has been separated from the group of MSB lines associated with the pixel 1430b, and one of the LSB lines has been separated from the group of LSB lines associated with the pixel 1430b. In the aspect illustrated in FIG. 14, the separate MSB line and separated LSB line have been grouped together. Thus, the lines 1410 are more evenly distributed across the pixel 1430.

Implementing the drive lines 1410 as shown in FIG. 14 may reduce the complexity of the display. For example, the busses 23 (see, for example, FIGS. 10a and 10b) may be formed with two electrically isolated portions instead of with three, as described above with respect to FIG. 13.

Further, in contrast to the aspect of the pixel 1430a illustrated in FIG. 13, display elements in the pixel 1430b which are driven by an MSB line include a shared electrode. Thus, when the segment driver 1204 applies a voltage to the MSB line, both of the elements that share the common electrode will receive the voltage. For example, the two red elements 1424 and 1426 in the pixel 1430b farthest from the common driver 1402 are formed with a common electrode. In some aspects, a single display element having an increased area is used instead of two separate display elements sharing a common electrode.

One having ordinary skill in the art will appreciate that lines or display elements described above as being arranged along a row may instead be arranged along a column, and vice versa. In some aspects, each pixel in a display is similarly configured. In other implementations, the configuration of some pixels varies within the display. For example, the rows of some pixels may be configured to display different colors than the rows of other pixels. In some aspects, every color within the pixel may not be associated with MSB data and LSB data. For example, each display element configured to display a given color in a pixel may be separately addressable using one or more of the driver configurations described above.

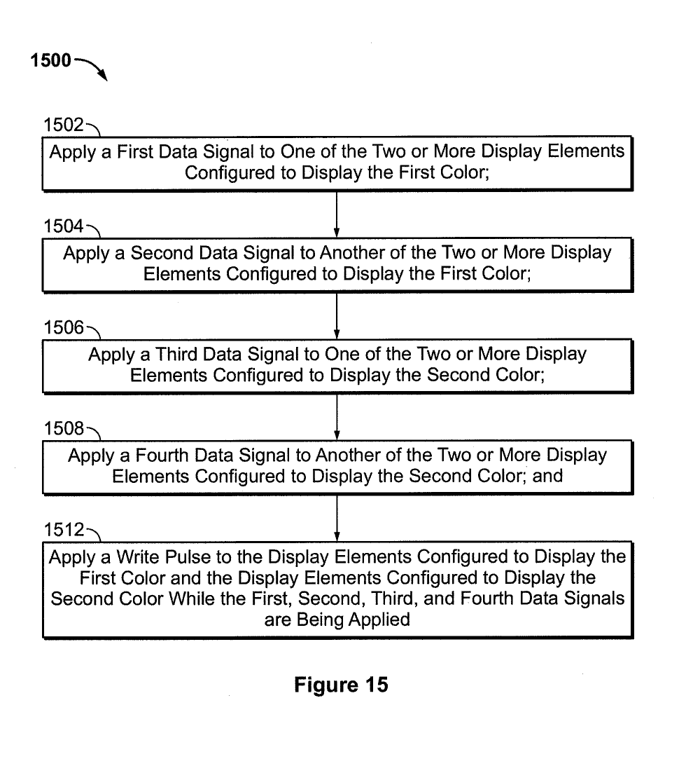

FIG. 15 shows an example of a flow diagram illustrating a process 1500 of driving a pixel. In some aspects, the pixel includes two or more display elements configured to display a first color and two or more display elements configured to display a second color. For example, the pixel 1130 of FIG. 11 is illustrated as having two display elements configured to display a red color, two display elements configured to display a green color, and two display elements to display a blue color. Each of the pixels 1230, 1430a, and 1430b of FIGS. 12, 13, and 14 respectively are illustrated as having three display elements of a first color, such as green, three elements of a second color, such as blue, and three elements of a third color, such as red. One having ordinary skill in the art will appreciate that while the process 1500 is described below with respect to elements of the display illustrated in FIG. 11, the process 1500 is not limited thereto. The process 1500 may be implemented using any number of different elements, including those of FIGS. 12, 13, and 14 as well as other arrangements. Further, one having ordinary skill in the art will appreciate that the process 1500 may comprise additional or fewer steps than illustrated in FIG. 15.

At block 1502, a first data signal is applied to one of the two or more display elements configured to display the first color. For example, the segment driver 1104 may apply a segment voltage to the larger red element in the pixel 1130. The segment voltage may be representative of data to be displayed by the larger red display element.

A second data signal is applied to another of the two or more display elements configured to display the first color at block 1504. For example, the segment driver 1104 may apply another segment voltage to the smaller red element in the pixel 1130. The segment voltage may be representative of data to be displayed by the smaller red display element.

At block 1506, a third data signal is applied to one of the two or more display elements configured to display the second color. For example, the segment driver 1104 may apply another segment voltage to the larger blue element in the pixel 1130. The segment voltage may be representative of data to be displayed by the larger blue display element.

At block 1508, a fourth data signal is applied to another of the two or more display elements configured to display the second color. For example, the segment driver 1104 may apply another segment voltage to the smaller blue element in the pixel 1130. The segment voltage may be representative of data to be displayed by the smaller blue display element. In some aspects, application of two or more of the signals at block 1502-1508 is offset in time. In other aspects, the first, second, third, and fourth signals are applied substantially contemporaneously.

While the first, second, third, and fourth data signals are being applied, a write pulse is applied to the display elements configured to display the first color and the display elements configured to display the second color at block 1512. For example, the common driver 1102 may pulse the red display elements and blue display elements in the pixel 1130 by applying a common voltage or signal to the pixel 1130 while the segment driver 1104 is applying the segment voltages to these display elements.

As discussed above, aspects described herein may be configured to reduce the write time for a display array. For example, aspects of a column driver and/or a segment driver illustrated in FIGS. 11-14 may write frames of display data more quickly than known common and segment drivers.

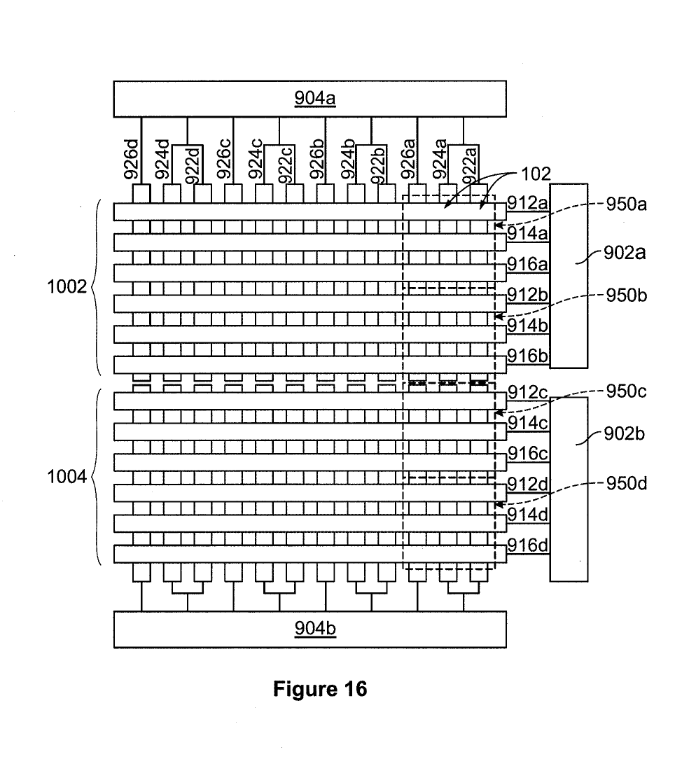

Another aspect of reducing the time required to write data to a display array includes separating the display array into two or more portions that can be driven in parallel. FIG. 16 shows a block diagram illustrating a common driver and two segment drivers for driving two sections of a color display simultaneously. The display array illustrated in FIG. 16 comprises two sections 1002 and 1004. Further, two segment drivers 904a and 904b may be provided to drive each of the sections 1002 and 1004, respectively.

To write lines of display data in parallel to the display array of FIG. 16, the segment drivers 904a and 904b may each apply voltages to the respective buses connected thereto. For example, segment driver 904a may output data for line 912a, and segment driver 904b may simultaneously output segment data for line 912c. Thereafter, the common driver 902a may pulse line 912a, and the common driver 902b may simultaneously apply a write pulse to line 912c, thus writing two lines simultaneously. This may be continued for each line of the array portions, typically cutting the time required to write a frame substantially in half when compared to the aspect illustrated in FIG. 9. In some aspects, a single common driver 902 is utilized instead of the two common drivers 902a and 902b.

In some aspects, a display array including two or more portions that can be driven in parallel, as illustrated in FIG. 16, may be combined with one or more of the drivers and/or pixels illustrated in FIGS. 11-14. For example, any of the segment drivers 1104, 1204, and 1404 may be used to implement the segment driver 904a. Similarly, the corresponding common driver 1102, 1202, or 1402 may be used to implement the common driver 902a, and the corresponding pixel 1130, 1230, or 1430 may be used to implement the pixel 950. Further, any of the segment drivers 1104, 1204, and 1404 may be used to implement the segment driver 904b, and any of the common drivers 1102, 1202, and 1402 may be used to implement the common driver 902b.

In some aspects, the implementation of the segment driver 904a is configured similar to the implementation of the segment driver 904b. For example, the segment driver 1404 may be used to implement both the segment driver 904a and the segment driver 904b. Similarly, the implementations of the common drivers 902a and 902b may be similar.

In some aspects, the implementation of the segment driver 904a is dissimilar to the implementation of the segment driver 904b. For example, the segment driver 1104 may be used to implement the segment driver 904a, while the segment driver 1204 is used to implement the segment driver 904b. Similarly, the implementations of the common drivers 902a and 902b may be dissimilar.

Further, the pixels in the section 1002 may be configured similar to the pixels in the section 1004 in some aspects. In other aspects, the pixels in the section 1002 differ from the pixels in the section 1004.

When a display array including two or more portions that can be driven in parallel is combined with one or more of the drivers and/or pixels illustrated in FIGS. 11-14, as described above, the write time for a display array may be further reduced. The drivers discussed above with respect to FIGS. 11-14 may allow data to be loaded onto a plurality of rows in a portion of the display substantially concurrently. Further, rows in the other portion of the display may be separately addressed substantially simultaneously. In some aspects, at least six rows of display elements may be concurrently addressed in this way.

FIG. 17 shows an example of a schematic circuit diagram illustrating an active matrix driving circuit for an optical MEMS display device. The driving circuit of FIG. 17 can be used for implementing an active matrix addressing scheme for providing image data simultaneously to multiple rows of display elements. The driving circuit of FIG. 17 can be used to provide data to multiple rows by increasing the number of segment outputs similar to the schemes described above with passive matrix addressing.

The driving circuit array includes a segment driver 1702, a common driver 1704, data driver output lines 1706 from the segment driver, gate driver output lines 1708 from the common driver, and an array of switches 1710, each having an output coupled to a display element 1720 of the array. The switches 1710 may be implemented as individual transistors having gates coupled to gate driver outputs 1708 of the common driver 1704. Each of the data driver output lines 1706 extends from the segment driver 1702, and is electrically connected to the inputs of a plurality of the switches 1710 in a column. In the implementation of FIG. 17, one electrode of each display element is grounded. In some implementations, this may be accomplished by depositing a continuous optical stack 16 onto the substrate and grounding the entire sheet at the periphery of the deposited layers. FIG. 17 shows a portion of the array having three rows and three columns, however, the array extends further to have N rows and M columns, repeating the configuration shown in FIG. 17 to form a complete display array.

Conventionally, a single data driver output 1706 would be associated with each column, and a separate gate driver output 1708 would be associated with each row. In FIG. 17, however, three data driver outputs are associated with each column. In this implementation, the data driver outputs can simultaneously supply data to the inputs of switches 1710 along three rows, rather than just one. This allows the common driver 1704 to apply the data to three rows of display elements simultaneously by asserting a single common driver output 1708.

The arrangement of different color display elements can in some implementations be the same for the active matrix of FIG. 17 as is the case with the passive matrix schemes described above. For example, the three rows illustrated in FIG. 17 may be a row of red display elements, a row of green display elements, and a row of blue display elements. The nine display elements shown in FIG. 17 may in this implementation form a color pixel as described above.

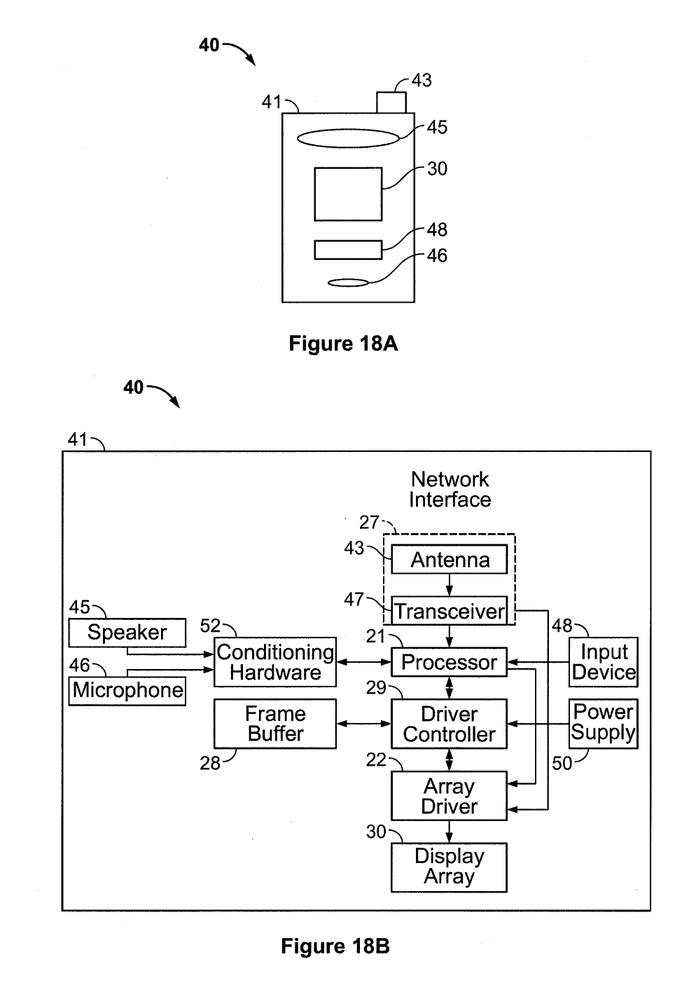

FIGS. 18A and 18B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 18B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display apparatus comprising:
M columns of display elements;
N rows of display elements; and
a common driver and a segment driver configured to passively address display elements in the M columns and N rows,
wherein the segment driver has a plurality of output lines, there being a greater number of output lines than columns of display elements, and wherein the segment driver is configured to independently address more than one row of display elements substantially concurrently such that more than one row of display elements are driven substantially concurrently by an output of the common driver.

2. The display apparatus of claim 1, wherein the common driver includes less than N outputs for driving the N rows of display elements.

3. The display apparatus of claim 2, wherein a pixel includes an array of display elements having at least two rows and is associated with one of the common driver outputs, and wherein the one of the common driver outputs is bifurcated so as to supply signals to the at least two rows substantially simultaneously.

4. The display apparatus of claim 3, wherein three rows of display elements are associated with three of the outputs of the common driver, and wherein the common driver is configured to supply signals to the three outputs substantially simultaneously.

5. The display apparatus of claim 1, wherein a pixel is formed by an array of nine display elements.

6. The display apparatus of claim 5, wherein the display elements of the pixel are arranged in an array comprising three rows and three columns.

7. The display apparatus of claim 1, wherein the segment driver is configured to supply signals to only a first portion of the N rows of display elements, and further comprising a second segment driver configured to supply signals to a second portion of the N rows of display elements.

8. The display apparatus of claim 7, wherein the common driver and the second segment driver are configured to passively address pixels in the second portion.

9. The display apparatus of claim 7, wherein the common driver is configured to supply a signal to a row in the first portion substantially concurrently with supplying a signal to a row in the second portion.

10. A device for displaying data, comprising:
an array of pixels, one or more of the pixels comprising at least two display elements configured to display a first color and at least two display elements configured to display a second color;
a common line driver; and
a segment driver,
wherein the common line driver and the segment line driver are configured to address one of the two display elements configured to display the first color independently of addressing the other of the two display elements configured to display the first color, and wherein the common line driver and the segment line driver are configured to address one of the two display elements configured to display the second color independently of addressing the other of the two display elements configured to display the second color, and
wherein the common line driver and the segment line driver are configured to drive the display elements configured to display the first color substantially concurrently with the display elements configured to display the second color.

11. The device of claim 10, wherein the array includes M columns of the pixels, and wherein the segment driver has 6M outputs for driving the pixels.

12. The device of claim 11, wherein the array includes N rows of the pixels, and wherein the common driver has N outputs for driving the pixels.

13. The device of claim 12, wherein at least one of the N outputs is bifurcated into two bus lines.

14. The device of claim 12, wherein the one display element configured to display the first color is substantially larger than the other display element configured to display the first color.

15. The device of claim 11, wherein the array comprises N rows of the pixels, and wherein the common driver has 3N outputs for driving the pixels.

16. The device of claim 15, wherein the one pixel is associated with three of the 3N outputs, and wherein the common driver is configured to apply signals to the three outputs substantially concurrently.

17. The device of claim 10, wherein the array comprises M rows of the pixels, and wherein the segment driver has 6M outputs for driving the pixels.

18. The device of claim 10, wherein the display elements configured to display the first color and the display elements configured to display the second color are disposed so as to dither output light.

19. The device of claim 10, wherein the display elements configured to display the first color and the display elements configured to display the second color comprise interferometric modulators.

20. The device of claim 10, further comprising:
a processor that is configured to communicate with the array of pixels, the processor being configured to process image data; and
a memory device that is configured to communicate with the processor.

21. The device of claim 20, further comprising a controller configured to send at least a portion of the image data to the common line driver and the segment driver.

22. The device of claim 20, further comprising an image source module configured to send the image data to the processor.

23. The device of claim 22, wherein the image source module includes at least one of a receiver, transceiver, and transmitter.

24. The device of claim 20, further comprising an input device configured to receive input data and to communicate the input data to the processor.

25. A method of driving a pixel comprising two or more display elements configured to display a first color and two or more display elements configured to display a second color, the method comprising:
applying a first data signal to one of the two or more display elements configured to display the first color;
applying a second data signal to another of the two or more display elements configured to display the first color;
applying a third data signal to one of the two or more display elements configured to display the second color;
applying a fourth data signal to another of the two or more display elements configured to display the second color; and
applying a write pulse to the display elements configured to display the first color and the display elements configured to display the second color while the first, second, third, and fourth data signals are being applied.

26. The method of claim 25, further comprising applying a fifth data signal to a first display element configured to display a third color, and applying a sixth data signal to a second display element configured to display the third color.

27. The method of claim 25, wherein the first data signal is applied to a third display element configured to display the first color, and wherein the third data signal is applied to a third display element configured to display the second color.

28. The method of claim 25, wherein applying the write pulse comprises applying the write pulse simultaneously over three separate bus lines.

29. The method of claim 25, wherein the pixel is substantially aligned with a plurality of pixels, wherein the method further comprises applying data signals to all display elements of the plurality of pixels, and wherein applying the write pulse comprises applying the write pulse to all display elements of the plurality of pixels while the data signals are being applied.

30. An apparatus for displaying information, comprising:
a first array of display elements including a plurality of rows and columns;
a first segment driver including a plurality of output lines, there being a greater number of output lines than columns in the first array, wherein the first segment driver is configured to independently address more than one row of the first array substantially concurrently;
a second array of display elements including a plurality of rows and columns; and
a second segment driver configured to address at least one row of the second array in parallel with the first segment driver addressing rows of the first array.

31. The apparatus of claim 30, wherein the second segment driver includes a second plurality of output lines, there being a greater number of second output lines than columns in the second array, and wherein the second segment driver is configured to address more than one row in the second array substantially concurrently.

32. The apparatus of claim 30, further comprising a common driver configured to apply a pulse to each of the more than one row while the more than one row is being addressed by the first segment driver.

33. The apparatus of claim 32, wherein the common driver is configured to apply a pulse to the at least one row while the at least one row is being addressed by the second segment driver.

34. The apparatus of claim 32, further comprising a second common driver, the second common driver being configured to apply a pulse to the at least one row while the at least one row is being addressed by the second segment driver.

35. A display apparatus comprising:
M columns of display elements;
N rows of display elements;
a switch associated with each display element for active matrix addressing of display elements;
a common driver having a plurality of gate driver output lines, there being a smaller number of gate driver output lines than rows of display elements,
a segment driver having a plurality of data driver output lines, there being a larger number of data driver output lines than columns of display elements;
wherein the common driver is configured to drive a gate of a plurality of switches in a corresponding plurality of rows of display elements; and
wherein the segment driver is configured to independently address more than one row of display elements substantially concurrently such that more than one row of display elements are driven substantially concurrently by an output of the common driver.

36. The display apparatus of claim 35, wherein the common driver includes less than N outputs for driving the N rows of display elements.

37. The display apparatus of claim 36, wherein a pixel includes an array of display elements having at least two rows and is associated with one of the common driver outputs, and wherein the one of the common driver outputs is bifurcated so as to supply signals to the at least two rows substantially simultaneously.

38. The display apparatus of claim 37, wherein three rows of display elements are associated with three of the outputs of the common driver, and wherein the common driver is configured to supply signals to the three outputs substantially simultaneously.

39. The display apparatus of claim 35, wherein a pixel is formed by an array of nine display elements.

40. The display apparatus of claim 39, wherein the display elements of the pixel are arranged in an array comprising three rows and three columns.
